(19) United States
(12) Patent Application Publication
(10) Pub. No.: US 2015/0279089 A1
(43) Pub. Date: Oct. 1, 2015

(54) STREAMING COMPRESSION ANTI-ALIASING APPROACH TO DEFERRED SHADING

(71) Applicants: Ethan Kerzner, Edina, MN (US); Marco Salvi, San Francisco, CA (US)

(72) Inventors: Ethan Kerzner, Edina, MN (US); Marco Salvi, San Francisco, CA (US)

(21) Appl. No.: 14/227,461

(22) Filed: Mar. 27, 2014

(51) Int. Cl. G06T 15/40; G06T 15/80

(52) U.S. Cl. CPC G06T 15/405; G06T 15/80

(57) ABSTRACT

Systems and methods may provide for receiving fragment data for a pixel of an image at a deferred shader stage of a rendering pipeline and identifying one or more surfaces in the pixel based on the fragment data. Additionally, each identified surface may be stored as an entry in a geometry buffer (G-buffer) corresponding to the pixel if a memory overflow condition for the G-buffer is not met. In one example, a weight is assigned to each surface in the G-buffer based on a coverage of the pixel by the surface and an occlusion status of the surface, and a color is resolved for the pixel based on the assigned weights.

### BACKGROUND

A wide variety of graphics applications such as, for example, three-dimensional (3D) gaming and other high resolution 3D rendering applications, may involve the real-time display of scenes containing overlapping surfaces, complex lighting conditions, and so forth. Anti-aliasing techniques such as, for example, multi-sample anti-aliasing (MSAA) may deliver sharper surface edges by using a greater number of visibility samples per pixel (e.g., 8×MSAA) during a geometry stage of the rendering pipeline. Moreover, deferred shading techniques may simplify processing in the presence of complex lighting conditions by delaying the shading of pixels until after the geometry stage has determined the visibility of each sample from the image. In such a case, a geometry buffer (G-buffer) may be used to store data for the deferred shader stage, wherein each sample may have an entry in the G-buffer. As anti-aliasing sample rates increase, however, the size of the G-buffer may also increase, which may in turn have a negative impact on memory availability, performance, power consumption and/or battery life.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a rendering pipeline according to an embodiment;

FIG. 2 is an illustration of an example of a pixel having a plurality of identified surfaces according to an embodiment;

FIG. 3 is an illustration of an example of a geometry buffer (G-buffer) according to an embodiment;

FIG. 4 is a flowchart of an example of a method of compressing image data according to an embodiment;

FIG. 5 is a flowchart of an example of a method of identifying surfaces according to an embodiment;

FIG. 6 is a block diagram of an example of streaming compression logic according to an embodiment;

FIGS. 7 and 8 are block diagrams of examples of systems according to embodiments; and

FIG. 9 is a block diagram of an example of a system having a small form factor according to an embodiment.

### DETAILED DESCRIPTION

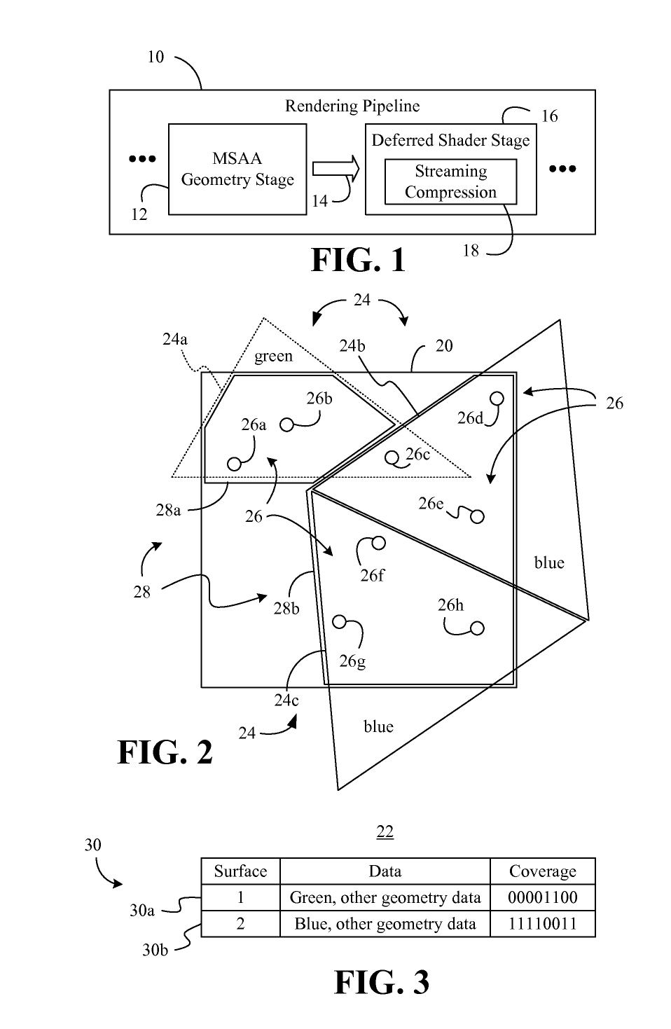

FIG. 1 shows a rendering pipeline 10 that may enable the real-time output of visual content associated with an application such as a 3D gaming, scientific visualization, digital pre-visualization (e.g., in movie production) and/or other rendering application. The rendering pipeline 10 may include a geometry stage such as, for example, a multi-sample anti-aliasing (MSAA) geometry stage 12 that samples geometry (e.g., determining which triangles cover particular locations in an image) and provides fragment data 14 to a deferred shader stage 16 based on the samples. The fragment data 14 may identify, for each pixel in the images (e.g., video frame), one or more fragments (e.g., triangle portions) that cover the pixels, as well as color, depth (e.g., distance from the camera and/or viewer), alignment and other image data sampled and/or calculated from those fragments in the pixels. The deferred shader stage 16 may generally use the fragment data 14 and a geometry buffer (G-buffer, not shown) to identify scene characteristics such as overlapping surfaces, shadows, etc., in the images and resolve colors for the pixels of the images based on the scene characteristics.

As will be discussed in greater detail, the deferred shader stage 16 may include streaming compression logic 18 to reduce the memory footprint of the G-buffer by tracking pixel information on a per surface basis rather than a per sample basis. The reduced memory footprint of the G-buffer may improve performance (e.g., by compressing the amount of image data that is processed), reduce power consumption and/or extend battery life. The streaming compression logic 18 may be particularly advantageous in the presence of the relatively high sample rates accompanying MSAA and other anti-aliasing techniques.

Turning now to FIGS. 2 and 3, a pixel 20 and G-buffer 22 are shown. In the illustrated example, a plurality of triangles, which have varying colors, depths, alignments, etc., partially cover the pixel 20. The portions of the triangles 24 that cover the pixel 20 may be referred to as fragments 24 (24a-24c). More particularly, a green fragment 24a is partially obscured in the pixel 20 by a first blue fragment 24b, in the illustrated example. Additionally, a second blue fragment 24c might partially cover the pixel 20. The fragment details provided herein are to facilitate discussion only, and may vary depending upon the content, application and/or circumstances.

A plurality of samples 26 (26a-26h) may be taken from the pixel 20 to determine the characteristics of the fragments 24, wherein the samples 26 may be incorporated into fragment data such as the fragment data 14 (FIG. 1) provided to a deferred shader stage such as the deferred shader stage 16. Accordingly, a first set of samples 26a, 26b might provide information regarding the green fragment 24a, a second set of samples 26c may provide information regarding the green fragment 24a and the first blue fragment 24b (e.g., including the overlapping nature of those fragments), a third set of samples 26d, 26e may provide information regarding the first blue fragment 24b, a fourth set of samples 26f-26h may provide information regarding the second blue fragment 24c, and so forth.

The fragment data represented by the samples 26 may be used to identify one or more surfaces 28 (28a, 28b) in the pixel 20, wherein the G-buffer 22 may contain each surface 28 as an entry 30 (30a, 30b). For example, a first entry 30a in the G-buffer might document that a first surface 28a is green and has a sample coverage of “00001100”, which may correspond to the first set of samples 26a, 26b. Similarly, a second entry 30b in the G-buffer 22 may document that a second surface 28b is blue and has a sample coverage of “11110011”, which may correspond to the second, third and fourth sets of samples 26c-26h. The entries 30 may also include other geometry data such as, for example, depth, alignment, weights and other image data. Thus, data is stored to the G-buffer 22 on a per surface basis rather than a per sample basis, in the illustrated example. As a result, the size of the illustrated G-buffer 22 is reduced, for example, from eight samples to two surfaces relative to a conventional G-buffer for the same pixel 20. The illustrated approach therefore compresses the amount of image data being processed, reduces the memory footprint of the G-buffer 22, improves performance, reduces power consumption and/or extends battery life.

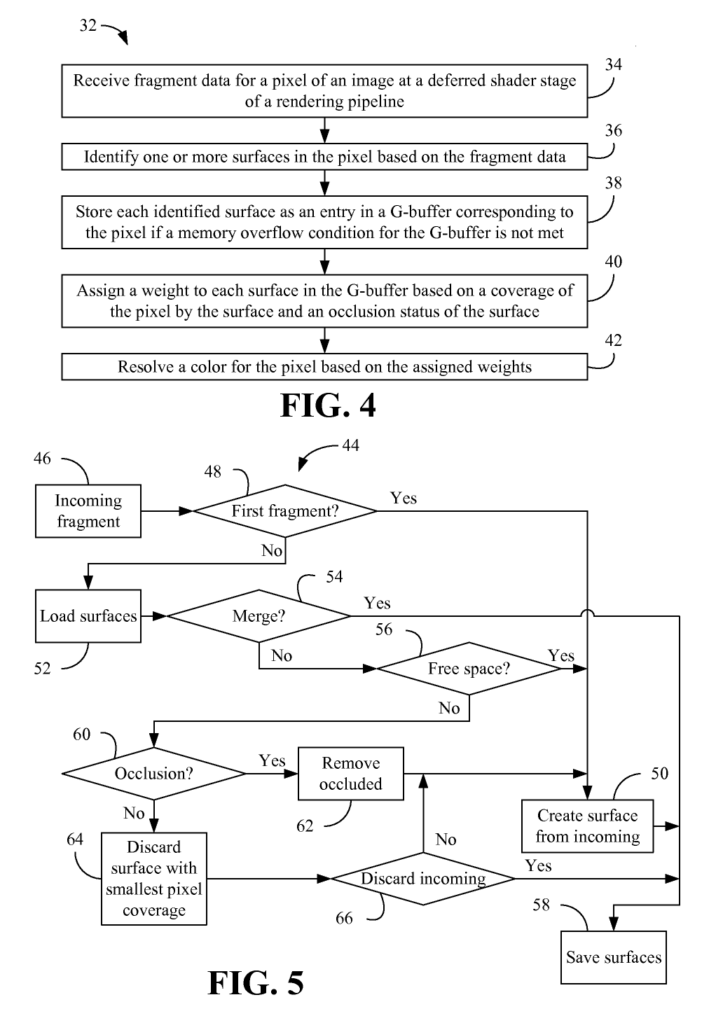

FIG. 4 shows a method 32 of compressing image data. The method 32 may be implemented in one or more modules as a set of logic instructions stored in a machine- or computer-readable storage medium such as random access memory (RAM), read only memory (ROM), programmable ROM (PROM), flash memory, etc., as configurable logic such as, for example, programmable logic arrays (PLAs), field programmable gate arrays (FPGAs), complex programmable logic devices (CPLDs), as fixed-functionality logic hardware using circuit technology such as, for example, application specific integrated circuit (ASIC), CMOS or transistor-transistor logic (TTL) technology, or any combination thereof. For example, computer program code to carry out operations shown in the method 32 may be written in any combination of one or more programming languages, including an object oriented programming language such as C++ or the like and conventional procedural programming languages, such as the “C” programming language or similar programming languages. Moreover, the method 32 may be implemented using any of the herein mentioned circuit technologies.

The method 32 may generally be repeated in serial or parallel (e.g., by a plurality of graphics processor threads) for a plurality of pixels in an image such as a frame generated from 3D geometry. More particularly, illustrated processing block 34 receives fragment data for a pixel of an image at a deferred shader stage of a rendering pipeline. One or more surfaces may be identified in the pixel at block 36 based on the fragment data, wherein illustrated block 38 provides for storing each identified surface as an entry in a G-buffer corresponding to the pixel if a memory overflow condition (e.g., maximum of two or three surfaces) for the G-buffer is not met. Additionally, a weight may be assigned to each surface in the G-buffer at block 40 based on the coverage of the pixel by the surface and the occlusion status (e.g., occluded by another surface, not occluded by another surface) of the surface. In the illustrated example, block 42 resolves a color for the pixel based on the assigned weights.

For example, a weighted average may be used to resolve pixel color, with shading only being conducted once per surface. The weight assigned to each surface may be the number of samples that the surface covers, accounting for occlusion by other surfaces.

FIG. 5 shows a method 44 of identifying surfaces. The method 44 may therefore be readily substituted for processing block 36 (FIG. 4), already discussed. More particularly, illustrated block 46 receives an incoming fragment such as, for example, one of the plurality of fragments 24 (FIG. 2), already discussed. A determination may be made at block 48 as to whether the received fragment is the first fragment received for the pixel in question. If so, a surface may be created for the fragment at block 50. Otherwise, illustrated block 52 loads the surfaces that have already been stored, wherein a determination may be made at block 54 as to whether the received fragment is to be merged with one of the loaded surfaces (e.g., the fragment is part of a surface that has already been identified). Block 54 may take into consideration a number of factors such as, for example, pixel coverage, alignment, depth, and so forth.

Pixel Coverage

For example, if the received fragment and a surface that has already been identified (e.g., an “identified surface”) have mutually exclusive coverage (e.g., no overlap) of the pixel, such a condition may be indicative of the fragment being part of the identified surface. Thus, with continuing reference to FIGS. 2 and 5, if a surface is initially created from the first blue fragment 24b and then the second blue fragment 24c is received, it may be determined at block 54 that the second blue fragment 24c and the first blue fragment 24b do not overlap (e.g., have mutually exclusive coverage). In such a case, the first blue fragment 24b and the second blue fragment 24c might be merged into the same second surface 28b (e.g., subject to other alignment and/or depth conditions being met) and the second surface 28b may be saved to the G-buffer at block 58. Pixel coverage may be determined based on the samples 26. Saving the second surface 28b to the G-buffer in such a case may involve incorporating fragment data corresponding to the identified surface into an entry in the G-buffer.

If, on the other hand, the pixel coverage for the green fragment 24a is compared to the pixel coverage for the first blue fragment 24b, it may be determined at block 54 that the green fragment 24a and the first blue fragment 24b do not have mutually exclusive coverage of the pixel 20. In such a case, the first surface 28a may be created from the green fragment 24a (e.g., subject to space availability in the G-buffer).

Alignment

The received fragment and an identified surface having a common alignment may also be indicative of the received fragment being part of the identified surface. For example, if a surface is initially created from the first blue fragment 24b and then the second blue fragment 24c is received, it may be determined at block 54 that the second blue fragment 24c and the first blue fragment 24b lie in substantially parallel planes in 3D space (e.g., common alignment). In such a case, the first blue fragment 24b and the second blue fragment 24c might be merged into the same second surface 28b (e.g., subject to other pixel coverage and/or depth conditions being met) and the second surface 28b may be saved to the G-buffer at block 58. If, on the other hand, the alignment for the green fragment 24a is compared to the alignment for the first blue fragment 24b, it may be determined at block 54 that the green fragment 24a and the first blue fragment 24b do not have a common alignment. In such a case, the first surface 28a may be created from the green fragment 24a (e.g., subject to space availability in the G-buffer).

Depth

Additionally, the received fragment and an identified surface having substantially equal depths in the pixel 20 may be indicative of the received fragment being part of the identified surface. For example, if a surface is initially created from the first blue fragment 24b and then the second blue fragment 24c is received, it may be determined at block 54 that the second blue fragment 24c and the first blue fragment 24b have substantially equal depths in the pixel 20 (e.g., same distance from the camera and/or viewer). In such a case, the first blue fragment 24b and the second blue fragment 24c might be merged into the same second surface 28b (e.g., subject to other pixel coverage and/or alignment conditions being met) and the second surface 28b may be saved to the G-buffer at block 58. If, on the other hand, the depth for the green fragment 24a is compared to the depth for the first blue fragment 24b, it may be determined at block 54 that the green fragment 24a and the first blue fragment 24b do not have substantially equal depths in the pixel 20. In such a case, the first surface 28a may be created from the green fragment 24a (e.g., subject to space availability in the G-buffer).

Thus, if it is determined at block 54 that the received fragment is not to be merged with any of the surfaces already stored in the G-buffer, a determination may be made at block 56 as to whether there is sufficient memory space to add another surface to the G-buffer. In this regard, a relatively small amount of memory may be allocated to the G-buffer, wherein the size of that memory is largely independent from the number of samples. Rather, the size of the memory may be based on a certain number of surfaces (e.g., three or less) that are likely to provide sufficient image quality in the rendering process.

If sufficient memory space exists, a surface is created from the received fragment at illustrated block 50. If there is insufficient memory space to add another surface to the G-buffer (e.g., a memory overflow condition is met), illustrated block 60 determines whether one of the identified surfaces is occluded by another identified surface. If so, the occluded surface may be discarded/removed at block 62 and a surface may created from the received fragment at block 50.

If, on the other hand, none of the identified surfaces is occluded by another surface, block 64 may discard/remove the surface with the smallest pixel coverage (e.g., based on the samples). A determination may be made at block 66 as to whether the received fragment was discarded. If so, the surfaces may be saved to the G-buffer at block 58. Otherwise, the received fragment may be used to create a surface at block 50, wherein illustrated block 58 then saves the surfaces to the G-buffer.

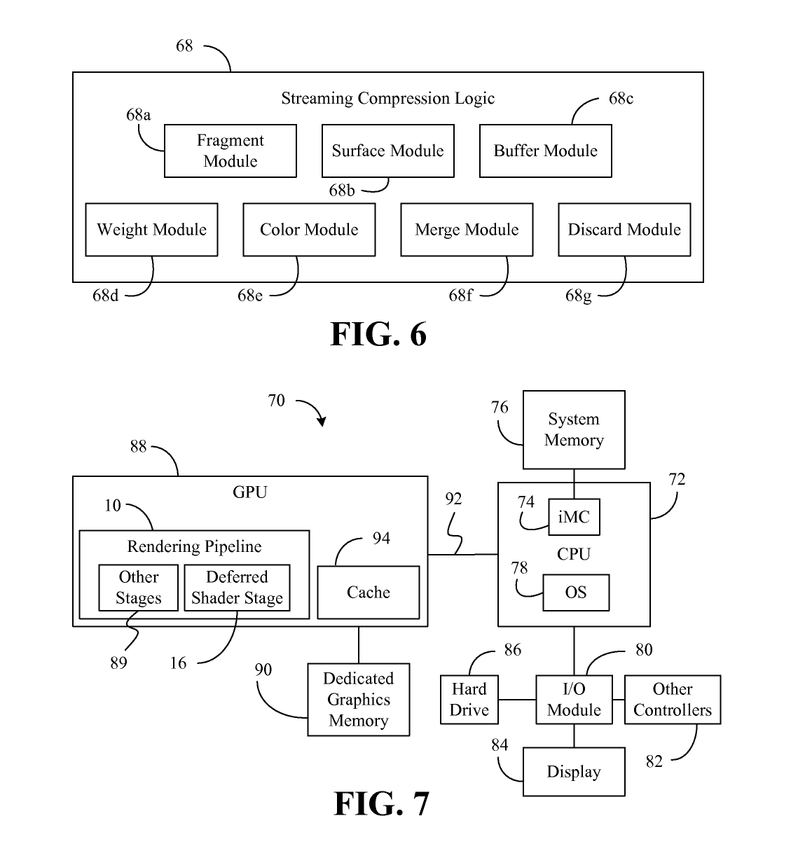

FIG. 6 shows streaming compression logic 68 (68a-68g). The streaming compression logic 68 may readily be substituted for the streaming compression logic 18 (FIG. 1), already discussed. In the illustrated example, the logic 68 includes a fragment module 68a that receives fragment data from for a pixel of an image and a surface module 68b to identify one or more surfaces in the pixel based on the fragment data. Additionally, a buffer module 68c may store each identified surface as an entry in a G-buffer corresponding to the pixel if a memory overflow condition for the G-buffer is not met. As already noted, the buffer module 68c may incorporate fragment data corresponding to each identified surface into the entry. The illustrated logic 68 also includes a weight module 68d to assign a weight to each surface in the G-buffer based on the coverage of the pixel by the surfaces and an occlusion status of the surface. Moreover, a color module 68e may resolve a color for the pixel based on the assigned weights.

In one example, a merge module 68f merges two or more identified surfaces together if the two or more identified surfaces have one or more of mutually exclusive coverage of the pixel, a common alignment in the pixel or substantially equally depths in the pixel. In another example, merging may take place only if all three conditions (e.g., pixel coverage, depth, alignment) exist. The logic 68 may also include a discard module 68g to discard one or more identified surfaces if a memory overflow condition for the G-buffer is met and the one or more identified surfaces is occluded by another surface in the pixel. In addition, the discard module 68g may discard one or more identified surfaces if a memory overflow condition for the G-buffer is met and the one or more identified surfaces has a smallest pixel coverage relative to other surfaces stored in the G-buffer.

Turning now to FIG. 7, a computing system 70 is shown, wherein the system 70 may be part of a mobile platform such as a laptop, wearable computer, mobile Internet device (MID), personal digital assistant (PDA), media player, imaging device, etc., any smart device such as a smart phone, tablet computer, smart TV (television) and so forth, or any combination thereof. The system 70 may also be part of a fixed platform such as a personal computer (PC), server, workstation, etc. The illustrated system 70 includes a central processing unit (CPU, e.g., host processor) 72 with an integrated memory controller (iMC) 74 that provides access to system memory 76, which may include, for example, double data rate (DDR) synchronous dynamic random access memory (SDRAM, e.g., DDR3 SDRAM JEDEC Standard JESD79-3C, April 2008) modules. The modules of the system memory 76 may be incorporated, for example, into a single inline memory module (SIMM), dual inline memory module (DIMM), small outline DIMM (SODIMM), and so on.

The CPU 72 may also have one or processor cores (not shown), where each core may be fully functional with instruction fetch units, instruction decoders, level one (L1) cache, execution units, and so on. The CPU 72 may alternatively communicate with an off-chip variation of the iMC 74, also known as a Northbridge, via a front side bus or a point-to-point fabric that interconnects each of the components in the system 70. The CPU 72 may also execute an operating system (OS) 78.

The illustrated CPU 72 communicates with an input/output (TO) module 80, also known as a Southbridge, via a bus. The iMC 74/CPU 72 and the IO module 80 are sometimes referred to as a chipset. The CPU 72 may also be operatively connected to a network (not shown) via a network port through the IO module 80 and various other controllers 82. Thus, the other controllers 82 may provide off-platform communication functionality for a wide variety of purposes such as wired communication or wireless communication including, but not limited to, cellular telephone (e.g., Wideband Code Division Multiple Access, W-CDMA (Universal Mobile Telecommunications System/UMTS), CDMA2000 (IS-856/IS-2000), etc.), Wi-Fi (Wireless Fidelity, e.g., Institute of Electrical and Electronics Engineers/IEEE 802.11, 2007 Edition), Bluetooth (e.g., IEEE 802.15.1-2005, Wireless Personal Area Networks), WiMax (e.g., IEEE 802.16-2004), Global Positioning System (GPS), spread spectrum (e.g., 900 MHz), and other radio frequency (RF) telephony purposes. The 10 module 80 may also communicate with a display 84 to provide for the visual output of video, images, and so forth. The other controllers 82 may also communicate with the 10 module 80 to provide support for user interface devices (not shown) such as a keypad, mouse, etc., in order to allow a user to interact with and perceive information from the system 70.

The 10 module 80 may also have internal controllers such as USB (Universal Serial Bus, e.g., USB Specification 2.0, USB Implementers Forum), Serial ATA (SATA, e.g., SATA Rev. 3.0 Specification, May 27, 2009, SATA International Organization/SATA-IO), High Definition Audio, and other controllers. The illustrated 10 module 80 is also coupled to storage, which may include a hard drive 86, solid state disk/SSD, read only memory (ROM), optical disk, flash memory (not shown), etc.

The illustrated system 70 also includes a dedicated graphics processing unit (GPU, e.g., graphics processor) 88 coupled to a dedicated graphics memory 90. The dedicated graphics memory 90 may include, for example, GDDR (graphics DDR) or DDR SDRAM modules, or any other memory technology suitable for supporting graphics rendering. The GPU 88 and graphics memory 90 might be installed on a graphics/video card, wherein the GPU 88 may communicate with the CPU 72 via a graphics bus 92 such as a PCI Express Graphics (PEG, e.g., Peripheral Components Interconnect/PCI Express x16 Graphics 150W-ATX Specification 1.0, PCI Special Interest Group) bus, or Accelerated Graphics Port (e.g., AGP V3.0 Interface Specification, September 2002) bus. The graphics card may be integrated onto the system motherboard, into the main CPU 72 die, configured as a discrete card on the motherboard, etc. The GPU 88 may also include an internal cache 94 to store instructions and other data.

The illustrated GPU 88 includes a rendering pipeline 10 having a deferred shader stage 16, already discussed. Thus, the deferred shader stage 16 may include streaming compression logic configured to receive fragment data for a pixel of an image, identify one or more surfaces in the pixel based on the fragment data, and store each identified surface as an entry in a G-buffer corresponding to the pixel if a memory overflow condition for the G-buffer is not met. The G-buffer may be stored in the cache 94, dedicated graphics memory 90, system memory 76, hard drive 86, etc., or any combination thereof. The illustrated rendering pipeline 10 also includes one or more other stages 89 to perform geometry, modeling, transformation, clipping, rasterization, texturing and other operations.

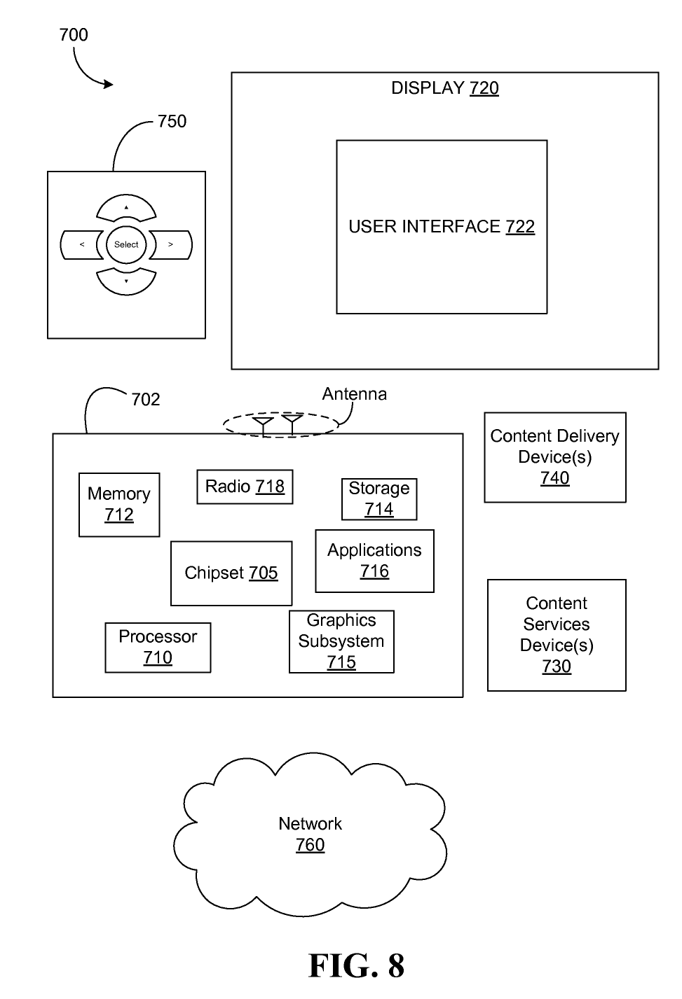

FIG. 8 illustrates an embodiment of a system 700 that may output visual content according to an embodiment. In embodiments, the system 700 may be a media system although system 700 is not limited to this context. For example, system 700 may be incorporated into a personal computer (PC), laptop computer, ultra-laptop computer, tablet computer, touch pad, portable computer, handheld computer, palmtop computer, personal digital assistant (PDA), cellular telephone, combination cellular telephone/PDA, television, smart device (e.g., smart phone or smart television), mobile internet device (MID), messaging device, data communication device, gaming console, and so on.

In embodiments, the system 700 comprises a platform 702 coupled to a display 720. The platform 702 may receive content from a content device such as content services device(s) 730 or content delivery device(s) 740 or other similar content sources. A navigation controller 750 comprising one or more navigation features may be used to interact with, for example, the platform 702 and/or display 720. Each of these components is described in more detail below.

In embodiments, the platform 702 may comprise any combination of a chipset 705, processor 710, memory 712, storage 714, graphics subsystem 715, applications 716 and/or radio 718. The chipset 705 may provide intercommunication among the processor 710, memory 712, storage 714, graphics subsystem 715, applications 716 and/or radio 718. For example, the chipset 705 may include a storage adapter (not depicted) capable of providing intercommunication with the storage 714.

The processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, the processor 710 may comprise dual-core processor(s), dual-core mobile processor(s), and so forth.

The memory 712 may be implemented as a volatile memory device such as, but not limited to, a Random Access Memory (RAM), Dynamic Random Access Memory (DRAM), or Static RAM (SRAM).

The storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, the storage 714 may comprise technology to increase the storage performance enhanced protection for valuable digital media when multiple hard drives are included, for example.

The graphics subsystem 715 may perform processing of images such as still or video for display. The graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. The graphics subsystem 715 could be integrated into the processor 710 or chipset 705. The graphics subsystem 715 could be a stand-alone card communicatively coupled to chipset 705. In one example, the graphics subsystem 715 functions similarly to the GPU 88 (FIG. 7) and the processor 710 functions similarly to the CPU 72 (FIG. 7), both already discussed.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, the radio 718 may operate in accordance with one or more applicable standards in any version.

In embodiments, the display 720 may comprise any television type monitor or display. The display 720 may comprise, for example, a computer display screen, touch screen display, video monitor, television-like device, and/or a television. The display 720 may be digital and/or analog. In embodiments, the display 720 may be a holographic display. Also, the display 720 may be a transparent surface that may receive a visual projection. Such projections may convey various forms of information, images, and/or objects. For example, such projections may be a visual overlay for a mobile augmented reality (MAR) application. Under the control of one or more software applications 716, the platform 702 may display a user interface 722 on the display 720.

In embodiments, the content services device(s) 730 may be hosted by any national, international and/or independent service and thus accessible to the platform 702 via the Internet, for example. The content services device(s) 730 may be coupled to the platform 702 and/or to the display 720. The platform 702 and/or content services device(s) 730 may be coupled to a network 760 to communicate (e.g., send and/or receive) media information to and from network 760. The content delivery device(s) 740 also may be coupled to platform 702 and/or to display 720.

In embodiments, the content services device(s) 730 may comprise a cable television box, personal computer, network, telephone, Internet enabled devices or appliance capable of delivering digital information and/or content, and any other similar device capable of unidirectionally or bidirectionally communicating content between content providers and the platform 702 and/display 720, via the network 760 or directly. It will be appreciated that the content may be communicated unidirectionally and/or bidirectionally to and from any one of the components in the system 700 and a content provider via the network 760. Examples of content may include any media information including, for example, video, music, medical and gaming information, and so forth.

The content services device(s) 730 receives content such as cable television programming including media information, digital information, and/or other content. Examples of content providers may include any cable or satellite television or radio or Internet content providers. The provided examples are not meant to limit embodiments.

In embodiments, the platform 702 may receive control signals from the navigation controller 750 having one or more navigation features. The navigation features of the controller 750 may be used to interact with the user interface 722, for example. In embodiments, the navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of the controller 750 may be echoed on a display such as, for example, the display 720, by movements of a pointer, cursor, focus ring, or other visual indicators displayed on the display. For example, under the control of the software applications 716, the navigation features located on the navigation controller 750 may be mapped to virtual navigation features displayed on the user interface 722, for example. In embodiments, the controller 750 may not be a separate component but integrated into the platform 702 and/or display 720. Embodiments, however, are not limited to the elements or in the context shown or described herein.

In embodiments, drivers (not shown) may comprise technology to enable users to instantly turn on and off the platform 702 like a television with the touch of a button after initial boot-up, when enabled, for example. Program logic may allow the platform 702 to stream content to media adaptors or other content services device(s) 730 or content delivery device(s) 740 when the platform is turned “off.” In addition, the chipset 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in the system 700 may be integrated. For example, the platform 702 and content services device(s) 730 may be integrated, or the platform 702 and content delivery device(s) 740 may be integrated, or the platform 702, content services device(s) 730, and the content delivery device(s) 740 may be integrated, for example. In various embodiments, the platform 702 and the display 720 may be an integrated unit. The display 720 and content service device(s) 730 may be integrated, or the display 720 and the content delivery device(s) 740 may be integrated, for example. These examples are not meant to limit the embodiments.

In various embodiments, the system 700 may be implemented as a wireless system, a wired system, or a combination of both. When implemented as a wireless system, the system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, the system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

The platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 8.

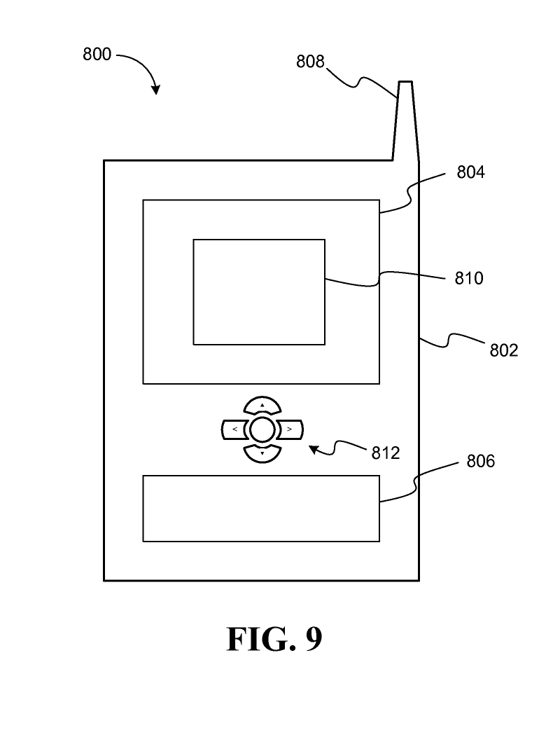

As described above, the system 700 may be embodied in varying physical styles or form factors. FIG. 9 illustrates embodiments of a small form factor device 800 in which the system 700 (FIG. 8) may be embodied. In embodiments, for example, the device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 9, the device 800 may comprise a housing 802, a display 804, an input/output (I/O) device 806, and an antenna 808. The device 800 also may comprise navigation features 812. The display 804 may comprise any suitable display unit for displaying information appropriate for a mobile computing device. The I/O device 806 may comprise any suitable I/O device for entering information into a mobile computing device. Examples for the I/O device 806 may include an alphanumeric keyboard, a numeric keypad, a touch pad, input keys, buttons, switches, rocker switches, microphones, speakers, voice recognition device and software, and so forth. Information also may be entered into the device 800 by way of a microphone. Such information may be digitized by a voice recognition device. The embodiments are not limited in this context.

### ADDITIONAL NOTES AND EXAMPLES

Example 1 may include a system to output visual content, comprising memory to store a geometry buffer (G-buffer) corresponding to a pixel of an image, and a rendering pipeline including a deferred shader stage having a fragment module to receive fragment data for the pixel, a surface module to identify one or more surfaces in the pixel based on the fragment data, and a buffer module to store each identified surface as an entry in the G-buffer if a memory overflow condition for the G-buffer is not met. The system may also include a display to output the visual content based on the G-buffer.

Example 2 may include the system of Example 1, wherein the deferred shader further includes a weight module to assign a weight to each surface in the G-buffer based on a coverage of the pixel by the surface and an occlusion status of the surface, and a color module to resolve a color for the pixel based on the assigned weights.

Example 3 may include the system of Example 1, wherein the deferred shader stage further includes a merge module to merge two or more identified surfaces together if the two or more identified surfaces have one or more of mutually exclusive coverage of the pixel, a common alignment in the pixel or substantially equal depths in the pixel.

Example 4 may include the system of any one of Examples 1 to 3, wherein the deferred shader stage further includes a discard module to discard one or more identified surfaces if a memory overflow condition for the G-buffer is met and the one or more identified surfaces is occluded by another surface in the pixel.

Example 5 may include the system of any one of Examples 1 to 3, wherein the deferred shader stage further includes a discard module to discard one or more identified surfaces if a memory overflow condition for the G-buffer is met and the one or more identified surfaces has a smallest pixel coverage relative to other surfaces stored in the G-buffer.

Example 6 may include the system of any one of Examples 1 to 3, wherein the buffer module is to incorporate fragment data corresponding to each identified surface into the entry.

Example 7 may include a method of compressing image data, comprising receiving fragment data for a pixel of an image at a deferred shader stage of a rendering pipeline, identifying one or more surfaces in the pixel based on the fragment data, and storing each identified surface as an entry in a G-buffer corresponding to the pixel if a memory overflow condition for the G-buffer is not met.

Example 8 may include the method of Example 7, further including assigning a weight to each surface in the G-buffer based on a coverage of the pixel by the surface and an occlusion status of the surface, and resolving a color for the pixel based on the assigned weights.

Example 9 may include the method of Example 7, further including merging two or more identified surfaces together if the two or more identified surfaces have one or more of mutually exclusive coverage of the pixel, a common alignment in the pixel or substantially equal depths in the pixel.

Example 10 may include the method of any one of Examples 7 to 9, further including discarding one or more identified surfaces if a memory overflow condition for the G-buffer is met and the one or more identified surfaces is occluded by another surface in the pixel.

Example 11 may include the method of any one of Examples 7 to 9, further including discarding one or more identified surfaces if a memory overflow condition for the G-buffer is met and the one or more identified surfaces has a smallest pixel coverage relative to other surfaces stored in the G-buffer.

Example 12 may include the method of any one of Examples 7 to 9, wherein storing each identified surface as an entry in the G-buffer includes incorporating fragment data corresponding to the identified surface into the entry.

Example 13 may include at least one computer readable storage medium comprising instructions which, when executed by a computing device, cause the computing device to receive fragment data for a pixel of an image at a deferred shader stage of a rendering pipeline, identify one or more surfaces in the pixel based on the fragment data, and store each identified surface as an entry in a G-buffer corresponding to the pixel if a memory overflow for the G-buffer is not met.

Example 14 may include the at least one computer readable storage medium of Example 13, wherein the instructions, when executed, cause a computing device to assign a weight to each surface in the G-buffer based on a coverage of the pixel by the surface and an occlusion status of the surface, and resolve a color for the pixel based on the assigned weights.

Example 15 may include the at least one computer readable storage medium of Example 13, wherein the instructions, when executed, cause a computing device to merge two or more identified surfaces together if the two or more identified surfaces have one or more of mutually exclusive coverage of the pixel, a common alignment in the pixel or substantially equal depths in the pixel.

Example 16 may include the at least one computer readable storage medium of any one of Examples 13 to 15, wherein the instructions, when executed, cause a computing device to discard one or more identified surfaces if a memory overflow condition for the G-buffer is met and the one or more identified surfaces is occluded by another surface in the pixel.

Example 17 may include the at least one computer readable storage medium of any one of Examples 13 to 15, wherein the instructions, when executed, cause a computing device to discard one or more identified surfaces if a memory overflow condition for the G-buffer is met and the one or more identified surfaces has a smallest pixel coverage relative to other surfaces stored in the G-buffer.

Example 18 may include the at least one computer readable storage medium of any one of Examples 13 to 15, wherein the instructions, when executed, cause a computing device to incorporate fragment data corresponding to each identified surface into the entry.

Example 19 may include a deferred shader stage comprising a fragment module to receive fragment data for a pixel of an image, a surface module to identify one or more surfaces in the pixel based on the fragment data, and a buffer module to store each identified surface as an entry in a G-buffer corresponding to the pixel if a memory overflow condition for the G-buffer is not met.

Example 20 may include the deferred shader stage of Example 19, further including a weight module to assign a weight to each surface in the G-buffer based on a coverage of the pixel by the surface and an occlusion status of the surface, and a color module to resolve a color for the pixel based on the assigned weights.

Example 21 may include the deferred shader stage of Example 19, further including a merge module to merge two or more identified surfaces together if the two or more identified surfaces have one or more of mutually exclusive coverage of the pixel, a common alignment in the pixel or substantially equal depths in the pixel.

Example 22 may include the deferred shader stage of any one of Examples 19 to 21, further including a discard module to discard one or more identified surfaces if a memory overflow condition for the G-buffer is met and the one or more identified surfaces is occluded by another surface in the pixel.

Example 23 may include the deferred shader stage of any one of Examples 19 to 21, further including a discard module to discard one or more identified surfaces if a memory overflow condition for the G-buffer is met and the one or more identified surfaces has a smallest pixel coverage relative to other surfaces stored in the G-buffer.

Example 24 may include the deferred shader stage of any one of Examples 19 to 21, wherein the buffer module is to incorporate fragment data corresponding to each identified surface into the entry.

Example 25 may include a deferred shader stage comprising means for performing the method of any one of examples 7 to 12.

Techniques described herein may therefore decouple sampling from G-buffer storage, enabling increased sampling rates with constant memory usage and near constant shading costs. More particularly, techniques may leverage the fact that in a typical scene, a few surfaces (e.g., three or less) often contribute to pixel color. As a result, a small fixed amount of memory may be used for the G-buffer, while increasing the visibility sampling rate to 8x or more.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Embodiments are applicable for use with all types of semiconductor integrated circuit (“IC”) chips. Examples of these IC chips include but are not limited to processors, controllers, chipset components, programmable logic arrays (PLAs), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated. Additionally, it is understood that the indefinite articles “a” or “an” carries the meaning of “one or more” or “at least one”.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A system to output visual content, comprising:
a memory to store a geometry buffer (G-buffer) corresponding to a pixel of an image;
a rendering pipeline including a deferred shader stage having,
a fragment module to receive fragment data for the pixel,
a surface module to identify one or more surfaces in the pixel based on the fragment data, and
a buffer module to store each identified surface as an entry in the G-buffer if a memory overflow condition for the G-buffer is not met; and
a display to output the visual content based on the G-buffer.

2. The system of claim 1, wherein the deferred shader further includes:
a weight module to assign a weight to each surface in the G-buffer based on a coverage of the pixel by the surface and an occlusion status of the surface; and
a color module to resolve a color for the pixel based on the assigned weights.

3. The system of claim 1, wherein the deferred shader stage further includes a merge module to merge two or more identified surfaces together if the two or more identified surfaces have one or more of mutually exclusive coverage of the pixel, a common alignment in the pixel or substantially equal depths in the pixel.

4. The system of claim 1, wherein the deferred shader stage further includes a discard module to discard one or more identified surfaces if a memory overflow condition for the G-buffer is met and the one or more identified surfaces is occluded by another surface in the pixel.

5. The system of claim 1, wherein the deferred shader stage further includes a discard module to discard one or more identified surfaces if a memory overflow condition for the G-buffer is met and the one or more identified surfaces has a smallest pixel coverage relative to other surfaces stored in the G-buffer.

6. The system of claim 1, wherein the buffer module is to incorporate fragment data corresponding to each identified surface into the entry.

7. A method comprising:
receiving fragment data for a pixel of an image at a deferred shader stage of a rendering pipeline;
identifying one or more surfaces in the pixel based on the fragment data; and
storing each identified surface as an entry in a geometry buffer (G-buffer) corresponding to the pixel if a memory overflow condition for the G-buffer is not met.

8. The method of claim 7, further including:
assigning a weight to each surface in the G-buffer based on a coverage of the pixel by the surface and an occlusion status of the surface; and
resolving a color for the pixel based on the assigned weights.

9. The method of claim 7, further including merging two or more identified surfaces together if the two or more identified surfaces have one or more of mutually exclusive coverage of the pixel, a common alignment in the pixel or substantially equal depths in the pixel.

10. The method of claim 7, further including discarding one or more identified surfaces if a memory overflow condition for the G-buffer is met and the one or more identified surfaces is occluded by another surface in the pixel.

11. The method of claim 7, further including discarding one or more identified surfaces if a memory overflow condition for the G-buffer is met and the one or more identified surfaces has a smallest pixel coverage relative to other surfaces stored in the G-buffer.

12. The method of claim 7, wherein storing each identified surface as an entry in the G-buffer includes incorporating fragment data corresponding to the identified surface into the entry.

13. At least one computer readable storage medium comprising instructions which, when executed by a computing device, cause the computing device to:
receive fragment data for a pixel of an image at a deferred shader stage of a rendering pipeline;
identify one or more surfaces in the pixel based on the fragment data; and
store each identified surface as an entry in a geometry buffer (G-buffer) corresponding to the pixel if a memory overflow condition for the G-buffer is not met.

14. The at least one computer readable storage medium of claim 13, wherein the instructions, when executed, cause a computing device to:
assign a weight to each surface in the G-buffer based on a coverage of the pixel by the surface and an occlusion status of the surface; and
resolve a color for the pixel based on the assigned weights.

15. The at least one computer readable storage medium of claim 13, wherein the instructions, when executed, cause a computing device to merge two or more identified surfaces together if the two or more identified surfaces have one or more of mutually exclusive coverage of the pixel, a common alignment in the pixel or substantially equal depths in the pixel.

16. The at least one computer readable storage medium of claim 13, wherein the instructions, when executed, cause a computing device to discard one or more identified surfaces if a memory overflow condition for the G-buffer is met and the one or more identified surfaces is occluded by another surface in the pixel.

17. The at least one computer readable storage medium of claim 13, wherein the instructions, when executed, cause a computing device to discard one or more identified surfaces if a memory overflow condition for the G-buffer is met and the one or more identified surfaces has a smallest pixel coverage relative to other surfaces stored in the G-buffer.

18. The at least one computer readable storage medium of claim 13, wherein the instructions, when executed, cause a computing device to incorporate fragment data corresponding to each identified surface into the entry.

19. A deferred shader stage comprising:
a fragment module to receive fragment data for a pixel of an image;
a surface module to identify one or more surfaces in the pixel based on the fragment data; and
a buffer module to store each identified surface as an entry in a geometry buffer (G-buffer) corresponding to the pixel if a memory overflow condition for the G-buffer is not met.

20. The deferred shader stage of claim 19, further including:
a weight module to assign a weight to each surface in the G-buffer based on a coverage of the pixel by the surface and an occlusion status of the surface; and
a color module to resolve a color for the pixel based on the assigned weights.

21. The deferred shader stage of claim 19, further including a merge module to merge two or more identified surfaces together if the two or more identified surfaces have one or more of mutually exclusive coverage of the pixel, a common alignment in the pixel or substantially equal depths in the pixel.

22. The deferred shader stage of claim 19, further including a discard module to discard one or more identified surfaces if a memory overflow condition for the G-buffer is met and the one or more identified surfaces is occluded by another surface in the pixel.

23. The deferred shader stage of claim 19, further including a discard module to discard one or more identified surfaces if a memory overflow condition for the G-buffer is met and the one or more identified surfaces has a smallest pixel coverage relative to other surfaces stored in the G-buffer.

24. The deferred shader stage of claim 19, wherein the buffer module is to incorporate fragment data corresponding to each identified surface into the entry.
